(19) United States
(12) Patent Application Publication
(10) Pub. No.: US 2020/0327497 A1
(43) Pub. Date: Oct. 15, 2020

(54) SYSTEM AND METHOD FOR LINEHAUL OPTIMIZATION

(71) Applicant: FEDERAL EXPRESS CORPORATION, Memphis, TN (US)

(72) Inventors: Saeed Zamiri MARVIZADEH, Collierville, TN (US); George RICHARDSON, Memphis, TN (US); Bala VAIDYANATHAN, Collierville, TN (US)

(73) Assignee: FEDERAL EXPRESS CORPORATION, Memphis, TN (US)

(21) Appl. No.: 16/839,243

(22) Filed: Apr. 3, 2020

Related U.S. Application Data
(60) Provisional application No. 62/832,610, filed on Apr. 11, 2019.

(51) Int. Cl. G06Q 10/08

(52) U.S. Cl. CPC G06Q 10/08355; G06Q 10/0833; G06Q 10/08345

(57) ABSTRACT

A shipment delivery system includes equipment units for delivering shipments from an origin to a destination, and a processor that executes instructions stored in a storage medium to perform operations. The operations include receiving information associated with a configuration of a baseline line haul network for transporting shipments between the origin and the destination, including scheduled paths between the origin and the destination. The operations include receiving a constraint associated with modifying the baseline line haul network. The operations also include determining an alternate path different, including an adhoc route between the origin and the destination. The operations include determining an objective function and generating an optimized line haul network based on the determined objective function and the at least one constraint. The system dispatches an equipment unit for transporting the shipments from the origin to the destination based on the optimized line haul network.

### CROSS-REFERENCE TO RELATED APPLICATION

This application is based on and claims benefit of priority from U.S. Provisional Patent Application No. 62/832,610, filed Apr. 11, 2019, which is incorporated herein by reference in its entirety.

### TECHNICAL FIELD

The present disclosure relates generally to linehaul operations, and more particularly to a system and method suitable for optimizing linehaul operations.

### BACKGROUND

In logistics, linehaul refers to the movement of freight by land, air or waterway between distant cities. Freight types vary in volume and weight, from small documents to heavy pallets. Courier, Express, and Parcel (CEP) providers as well as third-party logistics (3PL) providers transport freight from an origin to a destination. Less than Truckload (LTL) carriers transport freight from various senders at a given station, for example to an origin. At that station, freight with common destinations is consolidated in trailers for (long-distance) transport to a transfer station or to one or more of another station types (ex. distribution facilities). At a transfer station, freight coming from different origins may be sorted and consolidated again for further transport to its destination. The supporting infrastructure of transfer stations, distribution facilities, tractors, trailers, dockworkers, and drivers is collectively called linehaul network (LN).

Freight transportation companies face two considerations that they typically balance: (1) keeping to the strict service level agreements (SLAs) they have with their customers, and (2) keeping costs down. Optimizing a LN can lead to considerable savings on logistics costs without compromising SLAs. Some examples of the complexity in creating an efficient LN include taking into consideration the time and cost associated with transfer stations, and identifying the optimal routing of each flow from a starting location to a destination location, as well as calculating and controlling the costs of owned resources and the tariffs from sub-contractors. As a result, a linehaul network is a highly complex system marked by several dependencies between the orders, the routes, the resources, and any disruptive events. Advanced optimization technology is, therefore, crucial to achieving efficiency in planning and execution.

A LN may have a hub-and-spoke configuration 10 as shown in FIG. 1A where a vehicle transports shipment along routes R1-R4 between the main hub 11, and various stations 12-15 (e.g., Station 1 through Station 4 as shown in FIG. 1A). Alternatively, LN may have a so called “milk-run” configuration as shown in FIG. 1B. Milk-run networks may be utilized in geographic areas where a company's shipment density is low, and they may be most economical when the inbound and outbound volume of each station is less than a truckload. However, milk-run networks are difficult to design and operate efficiently. As shown in FIG. 1B, milk-run network 16 may include a route R5 that connects several stations 12-15 (e.g., Station 1 through Station 4), and hub 11. As shown in FIG. 1B, a single vehicle 143 may travel on segments between hub 11 and stations 12-15, as well as on segments between stations 12-15 (e.g., L1-L5). Vehicle 143 may carry shipments for the stations Station 1 through Station 4.

### SUMMARY

One aspect of the present disclosure is directed to a shipment delivery system. The shipment delivery system may include a plurality of shipments for delivery to a destination station from an origin station and a plurality of equipment units configured to deliver the shipments. The shipment delivery system may also include a storage medium storing instructions and a processor configured to execute the stored instructions to perform operations. The operations may include receiving information associated with a configuration of a baseline line haul network for transporting the shipments between the origin station and the destination station, the information including a plurality of scheduled paths between the origin station and the destination station. The operations may also include receiving at least one constraint associated with modifying the baseline line haul network. The operations may further include determining an alternate path different from the scheduled paths, the alternate path including an adhoc route between the origin station and the destination station. The operations may include determining an objective function associated with transporting the shipments from the origin station to the destination station using selected ones of the scheduled paths and the alternate path, and at least one equipment unit from the plurality of equipment units. The operations may also include generating an optimized line haul network based on the determined objective function and the at least one constraint. Additionally, the operations may include dispatching the at least one equipment unit for transporting the shipments from the origin station to the destination station based on the optimized line haul network.

Another aspect of the present disclosure is directed to a method of delivering shipments. The method may include receiving, by a processor, information associated with a configuration of a baseline line haul network for transporting shipments between an origin station and a destination station, the information including a plurality of scheduled paths between the origin station and the destination station. The method may also include receiving, by the processor, at least one constraint associated with modifying the baseline line haul network. The method may further include determining, using the processor, an alternate path different from the scheduled paths, the alternate path including an adhoc route between the origin station and the destination station. The method may include determining, using the processor, an objective function associated with transporting the shipments from the origin station to the destination station using selected ones of the scheduled paths and the alternate path. The method may also include generating, using the processor, an optimized line haul network based on the determined objective function and the at least one constraint. Additionally, the method may include dispatching one or more equipment units for transporting the shipments from the origin station to the destination station based on the optimized line haul network.

### BRIEF DESCRIPTION OF THE DRAWINGS

The accompanying drawings are not necessarily to scale or exhaustive. Instead, the emphasis is generally placed upon illustrating the principles of the inventions described herein. These drawings, which are incorporated in and constitute a part of this specification, illustrate several embodiments consistent with the disclosure and, together with the detailed description, serve to explain the principles of the disclosure. In the drawings:

FIGS. 1A and 1B are exemplary diagrams of a hub-and-spoke network configuration and a milk-run configuration, respectively.

FIG. 2 is a diagram of an exemplary linehaul network, consistent with disclosed embodiments.

FIG. 3 is a diagram of some exemplary components of a shipment delivery system, consistent with disclosed embodiments.

FIG. 4 is a flowchart of a process of optimizing a linehaul network consistent with disclosed embodiments.

FIGS. 5A and 5B are illustrative embodiments of baseline and optimized linehaul networks, respectively, consistent with disclosed embodiments.

FIG. 6 is a graph of illustrative reduction in cost as a function of the reduction in a service level, consistent with disclosed embodiments.

FIGS. 7A and 7B show exemplary baseline and an optimized linehaul networks, respectively, consistent with disclosed embodiments.

FIG. 8 is a diagram of an illustrative incremental optimization of a linehaul network using a shipment delivery system, consistent with disclosed embodiments.

FIG. 9 is a diagram of a process of selecting a change in parameters of a linehaul network using a shipment delivery system, consistent with disclosed embodiments.

FIG. 10 is a graph of example costs for various linehaul networks obtained by introducing a change in parameters of a baseline linehaul network, consistent with disclosed embodiments.

FIG. 11 is a diagram of combining several changes for optimizing a linehaul network consistent with disclosed embodiments.

FIG. 12 is a graph of exemplary costs and cost savings associated with optimizing a linehaul network, consistent with disclosed embodiments.

FIG. 13 is a graph of exemplary variations in demand, consistent with disclosed embodiments.

FIGS. 14A-14D are graphs of the exemplary costs and cost savings associated with optimizing a linehaul network, consistent with disclosed embodiments.

FIGS. 15A-15C illustrates graphs illustrating reduction in cost of a linehaul network as a function of time required to run different computer-based optimization models, consistent with disclosed embodiments.

FIG. 16 is a flowchart describing using a shipment delivery system for generating a data related to linehaul network, consistent with disclosed embodiments.

FIGS. 17-21 show exemplary embodiments of interfaces associated with a shipment delivery system, consistent with disclosed embodiments.

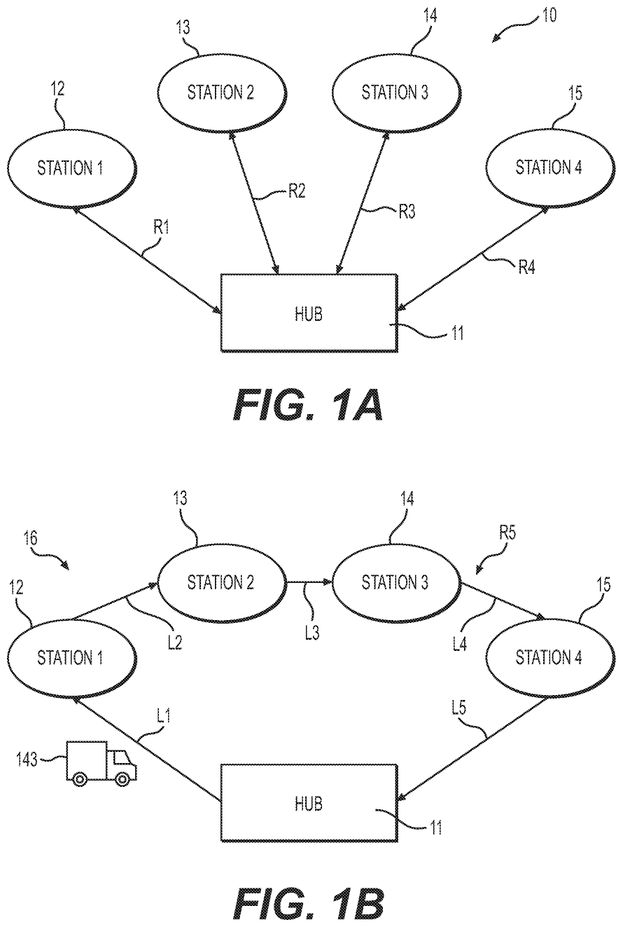

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical and/or scientific terms have meanings commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative and are not intended to be necessarily limiting.

Planning for large scale linehaul operations is one of the most challenging transportation operations problems due to the complexity (number of decision variables involved) and nature of the operations, including resources such as physical infrastructure, stations, transfers, and vehicles. The dynamic nature of linehaul operations may make it difficult for planners to make operational decisions and manual planning may be cumbersome and error-prone.

The present disclosure addresses the problem of linehaul optimization by developing a shipment delivery system aimed at optimizing milk-run LNs depending on changes in shipment demand between an origin (i.e., starting location) and a destination. Among the objectives of the disclosed shipment delivery system is to develop a customized solution procedure for real-world transportation problems.

To aid in the discussion of linehaul optimization, it is helpful to define various terms. Several terms may be used to describe the same concept. For example, the term “station” for the linehaul network (LN) may be used to describe a physical location that may be an origin or destination of a shipment as well as an intermediate location along a vehicle's route for delivering a shipment. Similarly, the term “node” may be used to describe a station of a LN in the context of a shipment delivery system. The origin may be referred to as the “origin,” “origin node,” “starting location,” or “origin station,” and the destination may be referred to as the “destination,” “destination node,” “destination location,” or “destination station.”

Unless otherwise noted, the term “demand” may refer to a collection of shipments between the origin node and the destination node, with a committed delivery time at the destination node. Unless otherwise noted, the term “leg” may refer to a connection between two nodes. And unless otherwise noted, the term “route” may refer to a collection of legs, that connect the origin node for the route (also referred to as a route origin node) to the destination node for the route (also referred to as a route destination node). A route may be associated with a single vehicle moving from the route origin node to the route destination node by traversing the legs connecting these two nodes. Unless otherwise specified, the term “path” may refer to a collection of routes which move demand from an origin node of the path to a destination node of the path. The term “path origin node” may be used in connection with an origin node for a given path, and the term “path destination node” may be used in connection with a destination node for the given path. In various embodiments, routes forming a path may be connected (i.e., an origin node of one route is connected to a destination node of another route) to form a complete path.

Also, the term “service level” may refer to a number of demands which transit from origin to destination node before their committed delivery time. And the term “scheduled route” may refer to a route which is dispatched regularly on a daily/weekly basis. The term “adhoc route” may refer to a route which does not have any preschedule departure timeline. Adhoc routes may be utilized if needed and may be operated by a third party vehicle. Therefore, adhoc routes may typically cost more than scheduled routes. As defined herein, unless otherwise noted, the term “scheduled path” may refer to a path which does not utilize any adhoc routes. The term “adhoc path” may refer to a path utilizing at least one adhoc route. The term “baseline path” may refer to a scheduled path which may be used in the existing, or baseline, milk-run LN. The term “equipment” may refer to a vehicle with a fixed capacity which may move from an origin node to a destination node of a route. In some cases, the term equipment may refer to one or more vehicles, and in some cases, the term “equipment” or “equipment unit” may refer to a single vehicle. In various embodiments, a different type of equipment may operate along the scheduled path and along the adhoc path. For example, a transportation company may operate various company's vehicles (e.g., large trucks, vans, etc.) along the scheduled path, and third party vehicles may operate along adhoc paths. In various embodiments, a path may have several routes connected to each other with each route having separate equipment. In an example embodiment, the term “transfer node” or “transfer station” may be used to indicate that demand from one equipment is transferred to another equipment at that node or station. For example, the transfer node may be a node connecting two routes that operate different equipment. The terms “level of utilization” or “equipment utilization” may refer to a percentage of occupied space for equipment when operating equipment along with a given path. For example, if the equipment is utilized by fifty percent, that may imply that equipment can take in twice as much load to be completely utilized. For example, if equipment can transport ten tons of shipments, and is transporting six tons of shipments, the equipment is utilized by sixty percent.

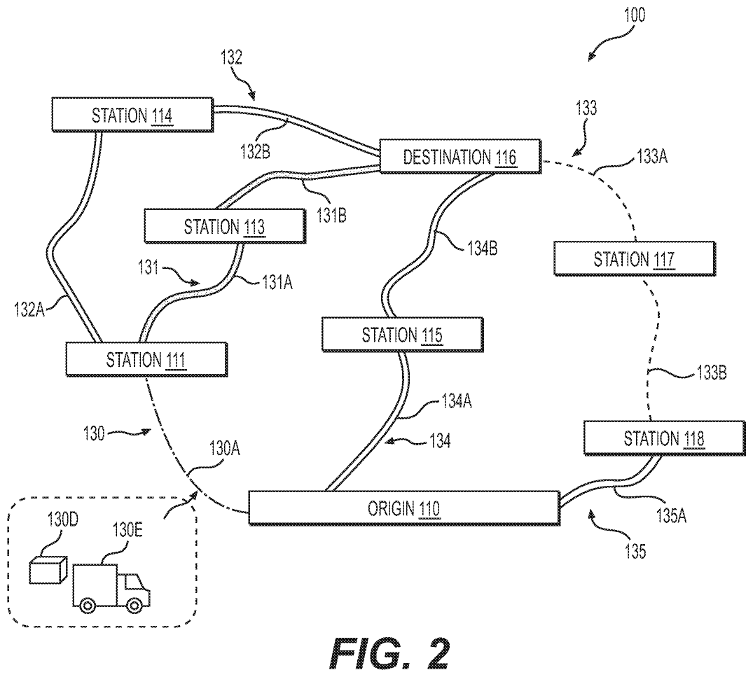

FIG. 2 shows an exemplary LN 100 for transporting a shipment from origin location 110 to destination location 116. In an example embodiment, LN 100 may include intermediate stations (e.g., Stations 111 through 118) that may be connected by routes 130-135. Each of intermediate stations 111-118 may be an intermediate starting station and/or an intermediate ending station. For example, when a shipment is transported from Station 111 to Station 113, Station 111 may be an intermediate staring station and Station 113 may be an intermediate ending station. In FIG. 2, route 130 may include leg 130A, route 131 may include legs 131A-131B, route 132 may include legs 132A-132B, route 133 may include legs 133A-133B, route 134 may include legs 134A-134B, and route 135 may include leg 135A. In various exemplary embodiments, routes 130 and 131 may form a first path from origin 110 to destination 116, routes 130, and 132 may form a second path from origin 110 to destination 116, route 134 may form a third path from origin 110 to destination 116, and routes 133 and 135 may form a fourth path from origin 110 to destination 116. In various exemplary embodiments, equipment may be assigned to a given route and may transport a corresponding demand. For simplicity of reference,

FIG. 2 shows that equipment for route 130 may be referenced by label 130E, and demand (e.g., one of more parcels, packages, and/or pallets) for route 130 may be referenced by label 130D. Thus, for example, the equipment for route 132 may be defined as equipment 132E, and demand for route 132 may be defined as demand 132D. It should be noted, that because demand may be transported from origin 110 to destination 116, demand 130D would be the same as demand 131D, but equipment 130E may be different from equipment 131E. In an example embodiment, station 111 may be a transfer station configured to unload demand 130D from equipment 130E (i.e., handover demand 130D to station 111), and upload demand 131D onto equipment 131E (i.e., retrieve demand 131D from station 111).

In various exemplary embodiments, routes 130-135 forming paths may be used to transport demand to destination 116. For example, the first path, the second path, and the third path may be used to transport the demand to destination 116, and the fourth path may be used to return equipment from destination 116 to origin 110. In various exemplary embodiments, LN 100 may maintain a network balance (i.e., LN may be balanced). As defined herein, unless otherwise noted, a balanced LN may require outgoing equipment (i.e., equipment leaving origin 110 towards destination 116) to return back to origin 110 after completion of transporting shipment to destination 116.

Before discussing various approaches used in optimizing LN 100, it should be noted that demand may travel along one scheduled path. In general, because equipment that travels along scheduled paths may be less expensive to operate, the scheduled paths may be considered as a first option when transporting demand, with the adhoc paths being considered as a secondary option (e.g., when there is not enough equipment along the scheduled paths to handle the demand, or when the cost of operating equipment along the scheduled paths is higher than the cost of operating equipment along the adhoc path). In some exemplary embodiments, the shipment delivery system may be configured to allow at most one adhoc path for a demand. In various exemplary embodiments, each node (e.g. nodes 110-116) of LN 100 may be capable of loading and unloading equipment. As explained above, one or more of routes 130-135 may be connected to form a path, wherein each route 130-135 may include two or more nodes in a sequence. Further, each route 130-135 may contain one or more legs (e.g. 131A, 131B, 132A, 132B, etc.) in a sequence, where each leg may include exactly two nodes. In various exemplary embodiments, routes may be balanced, i.e., if the equipment is utilized on a route with origin node N1 to destination node N2, equipment with same capacity may be utilized on a route from N2 to N1.

In various exemplary embodiments, demand moving on an adhoc path may arrive after the committed delivery time. As discussed above, adhoc routes may not necessarily need to be dispatched on a daily basis. Thus, their cost may be proportional to their daily utilization.

In some exemplary embodiments, optimizing LN 100 may include satisfying a minimum specified service level. For example, the minimum service level may include delivering 90% of the shipments (90% of demand) transported from the origin to the destination node at or before their committed delivery time. Other service level definitions are also contemplated (e.g. 70% of the shipments delivered before committed delivery time and 20% of the shipment delivered at committed delivery time). In various exemplary embodiments, baseline paths may be known for demands, and the set of routes that can be utilized to construct the optimal solution may be known. In various exemplary embodiments in order to obtain an optimal solution, the number of shipments that travel along scheduled paths different from their corresponding baseline paths may be predefined.

Optimization using an incremental approach may be particularly useful, for example, for LNs where changes to linehaul operations may be expensive. For instance, changes in vehicle routing may be expensive as various stations along the vehicle route may require appropriate updates and changes in procedures associated with changes in vehicle routing. Information about a change in vehicle routing may need to be distributed and processed by transfer stations, distribution facilities, equipment managers, dockworkers, and drivers. In various cases, a type of equipment at the transfer stations, and the number of dockworkers may need to be changed due to changes in vehicle routing. The cost associated with changes in vehicle routing may include costs of updating software for tracking equipment and shipment packages, cost of training dockworkers, as well as various other organizational costs associated with such changes. Thus, an optimization process that takes into account costs associated with vehicle routing changes may include gradual (i.e., incremental) vehicle routing changes.

In various exemplary embodiments, the optimization process may start from a baseline LN. For example, the baseline LN may correspond to an existing LN for a typical demand. A baseline LN may include a set of routes that may be taken by various vehicles. In some cases, baseline LN may be optimized for the typical demand (i.e., the number of shipments) and/or in some cases baseline LN may be optimized for the demand weight (i.e., the total weight of the shipments) or demand volume (i.e., the total volume of the shipments). In various exemplary embodiments, baseline LN may have sufficient flexibility to handle limited variations in demand. For example, LN may have sufficient flexibility to handle five to fifty percent increase/decrease in demand. For instance, when equipment operating along scheduled paths is not fully utilized, the equipment may incorporate an additional demand without the need for adding scheduled/adhoc path or changing baseline paths.

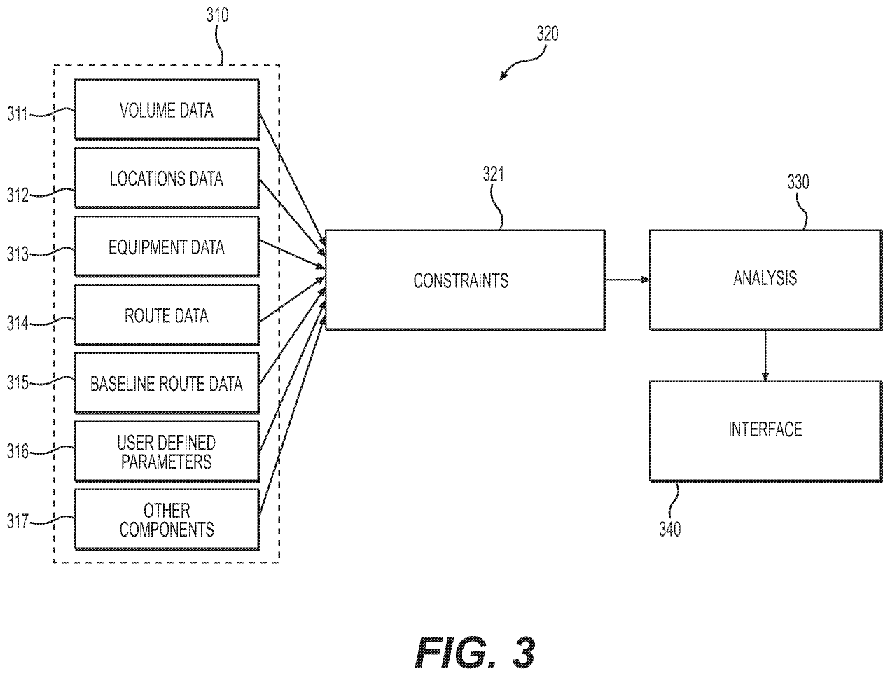

FIG. 3 shows exemplary components of a shipment delivery system 320 used in connection with overseeing operations of a LN. System 320 may receive inputs 310, reduce the linehaul costs subject to constraints 321, and output analysis data 330, which may be visualized using interface 340 of the system 320. It is contemplated that system 320 may include other components 317 such as buildings, facilities, personnel, and or equipment at one or more origins 110, destinations 116, one or more equipment units (e.g. Vehicle 143), and, for example, other types of equipment for loading and unloading shipments, etc. Inputs 310 may include information associated with a configuration of a line haul network LN 100. By way of example, such information may include one or more parameters associated with volume data 311, locations data 312, equipment data 313, route data 314, baseline route data 315, and user defined parameters 316. Volume data 311 may include one or more parameters describing an origin and destination (OD) pair. For example, volume data 311 may include information regarding origin 110 and destination 116. Additionally, for example, volume data 311 may include information (e.g., parameters) regarding demand 130D associated with the OD pair. By way of another example, volume data 311 may include parameters such as a starting location, a destination location, a baseline demand, and a set of scheduled paths used by the baseline LN.

Locations data 312 may include one or more parameters specifying information associated with stations along paths for OD. For example, locations data 312 may include information identifying locations of the one or more stations 111, 113, 114, 115, 117, 118, etc. Locations data 312 may include additional information, for example, handover and retrieval times, or descriptions of the largest equipment that can be handled at the one or more stations 111, 113, 114, 115, 117, 118, etc. By way of example, information about a transfer station may include time for handover (i.e., the time needed to remove the shipment from the equipment) and time for retrieval (i.e., the time needed to load the shipment to another equipment). It should be noted that the time for handover and the time for retrieval may depend on many factors that may include the type of equipment used.

Equipment data 313 may include one or more parameters, including information associated with equipment (e.g. 130E) that may travel along one or more routes 130, 131, 134, 135, etc. For example, equipment data may include parameters describing type of equipment, capacity of equipment, a travel range of equipment, or cost of operating a particular equipment. By way of another example, information about equipment for each route may include parameters such as equipment unit ID, equipment unit capacity, maximum distance that can be traveled by the equipment unit, cost of operating the equipment unit per unit distance, overhead cost of operating the equipment unit (e.g., cost of preparing the unit for transportation, cost of maintaining equipment, cleaning equipment, etc.), or any other suitable information that may be needed for optimizing the costs related to scheduled paths used for transportation of demand using a company's equipment.

Route data 314 may include information associated with one or more paths formed by connecting one or more of routes 130-135. For example, route data 314 may include one or more parameters including information describing various segments or legs on the one or more paths, travel distance associated with each of the oner or more paths, a type of equipment that can travel along the one or more paths, etc. Baseline route data 315 may include information regarding, for example, typical baseline demand for OD and committed service days for OD (e.g., expected number of shipment days by the user). By way of another example, route data 314 and/or baseline route data 315 may include information including aspects and elements of the path such as collection of routes forming the path, collection of legs forming various routes, a collection of nodes, equipment units used for each route, etc. The detailed information about the scheduled path may further include number of shipments along the path, a total weight of the shipments, a total volume of the shipments, information about the station (nodes) for the scheduled path (e.g., name, coordinates, region, state, station type, station identification (ID), type of equipment that can be handled by the station, preferred equipment for the station, the cost for loading and unloading associated with various equipment units, the number and the availability of tractors, trailers, dockworkers, and drivers, the availability of loading/unloading machines such as forklifts and pallet jacks, availability and size of storage, availability of containers, availability of docking stations, energy consumption costs associated with loading/unloading processing as well as sorting and tracking shipment for the station, safety record for the station, sanitization condition at the station).

In various exemplary embodiments, information about scheduled path may include one or more parameters including data about the legs for the scheduled path (e.g., length of the various legs, the expected duration of travel for the various legs, tolls on the various legs, weather conditions for the legs, expected time of the day for traveling along various legs, expected outside temperatures for the various legs, etc.).

In various exemplary embodiments, one or more parameters associated with an adhoc path that can be used for optimizing LN containing adhoc routes may include information (e.g., details about the legs for the adhoc route, equipment data such as equipment cost, etc.) similar to that used for scheduled paths containing respective routes, legs, and nodes. In various exemplary embodiments, information about adhoc route may include parameters such as committed service days (i.e., days needed to transport the shipment using third-party-owned vehicles), estimated departure and arrival times, third-party operator name, or any other suitable information that may be needed for optimizing the costs related to adhoc routes operated by third-party-owned vehicles.

In addition to the information about baseline LN, shipment delivery system 320 may receive a list of new scheduled paths that can be added to the LN, including the related information about the new scheduled paths (i.e., information similar to the input information that was used for scheduled paths of baseline LN).

User defined parameters 316 may include one or more parameters, for example, desired service level, desired number of routing changes, dimensional factor, request for creating adhoc routes and request for switching equipment as described above. Information regarding desired service level may include, for example, a range of service levels (e.g., range between eighty to ninety percent service level). Information regarding desired service level may also include an associated range of cost estimates for delivering a shipment to the destination.

In various exemplary embodiments, information regarding desired number of changes may include one or more parameters specifying a number of scheduled paths that can be added to or removed from the baseline LN, specifying a number of vehicles that can be added to or removed from a scheduled path that is part of the baseline LN or specifying changes in the number of shipments assigned to a given vehicle of the baseline LN. Various desired changes are further discussed below.

In various exemplary embodiments, information regarding adhoc routes may include parameters specifying, for example, cost of a chosen adhoc route such as costs associated with transporting shipments using third-party-owned vehicles, and/or overall decrease in a service level for the shipment when the adhoc route is added.

In various embodiments, a shipment delivery system (e.g. system 320) may be configured to receive user-defined parameters related to the optimization process. For example, shipment delivery system 320 may receive a service level parameter that may vary between zero and one that specifies the desired service level. For example, a choice of one may specify that the shipments are delivered before their committed delivery time, and the choice of 0.9 may specify that 90% of the shipments are delivered before their committed delivery time. Another parameter related to the optimization process may include a percentage change parameter ranging between zero and one. This parameter may specify the maximum percentage of routing changes. In a typical embodiment, the percentage change parameter may be 0.01 and may imply that at most 1% of routing changes can be used to optimize LN. Shipment delivery system 320 may further receive a typical connection time needed to transfer shipment at the transfer station. Shipment delivery system 320 also may receive a run parameter—a parameter defining the degree of optimization. For example, a run parameter may be a run time that defines the number of hours to run the program. Alternatively, the run parameter may be related to the degree of optimization achieved by the shipment delivery system that may be characterized by a decrease in an objective function as described below.

In various exemplary embodiments, user defined parameters 316 may also include dimensional factor parameter used to account for density/shape differences among shipments when loading equipment. For example, two shipments with the same weight may not necessarily have the same density/shape. With dimension factor of F and an equipment unit capacity of C, at most (1−F) C can be loaded onto the equipment unit. Another way to understand how the dimension factor F affects the shipment weight is to multiply each shipment weight wᵢ by a factor of 1+F to obtain an adjusted weight (1+F)wᵢ, and then select shipments for the equipment unit such that the total adjusted weight, (1+F)W (here W=Σwᵢ) is less than a total capacity of the equipment unit. In addition to the dimensional factor parameter, user defined parameters 316 may include a time interval over which to optimize LN (e.g., time interval characterized by a number of business days).

In various exemplary embodiments, user-defined parameters 316 may further include a request to create adhoc routes (e.g., the request may be a Yes/No choice) and a request to allow the shipment delivery system to switch equipment type (e.g., the request may be a Yes/No choice). For example, the request to switch equipment type may include the request to switch between a truck and a van for a given route used by a typical LN.

In various exemplary embodiments, shipment delivery system 320 for optimizing LN 100 may include various computing resources such as processors and tangible non-transitory computer-readable media. Shipment delivery system 320 may include programming instructions that may be executed, for example, by at least one processor that receives instructions from a non-transitory computer-readable storage medium. Similarly, systems and devices consistent with the present disclosure may include at least one processor and memory, and the memory may be a non-transitory computer-readable storage medium. As used herein, a non-transitory computer-readable storage medium may refer to any type of physical memory on which information or data readable by at least one processor can be stored. Examples may include random access memory (RAM), read-only memory (ROM), volatile memory, nonvolatile memory, hard drives, CD ROMs, DVDs, flash drives, disks, and any other known physical storage medium. Singular terms, such as “memory” and “computer-readable storage medium,” may additionally refer to multiple structures, such a plurality of memories or computer-readable storage mediums. As referred to herein, a “memory” may include any type of computer-readable storage medium unless otherwise specified. A computer-readable storage medium may store instructions for execution by at least one processor, including instructions for causing the processor to perform steps or stages consistent with an embodiment herein. Additionally, one or more computer-readable storage mediums may be utilized in implementing a computer implemented method. The term “computer-readable storage medium” should be understood to include tangible items and exclude carrier waves and transient signals.

In various exemplary embodiments, shipment delivery system 320 may utilize computing resources that may interact with one another via a network. The network facilitates communications and sharing of various data between the computing resources. The network may be any type of network that provides data communication. For example, the network may be the Internet, a Local Area Network, a cellular network, a public switched telephone network (“PSTN”), or other suitable connection(s) that computing resources to send and receive information. A network may support a variety of electronic data formats and may further support a variety of communication protocols for the computing devices.

After shipment delivery system 320 receives various input associated with baseline LN, as well as other inputs, as described above, related to optimizing LN, shipment delivery system 320 may proceed in finding possible routes forming paths for OD pair. The process of finding possible routes may take into account various constraints 321. By way of example, constraints 321 may include a requirement of maintaining a minimum service level as described above, requiring network balance, limiting the number of routing changes, requirement to have one scheduled path for OD pair and have at most one adhoc path for OD pair, etc.

System 320 may output analysis data 330 that may include baseline and optimized LN metrics such as total cost associated with operations of baseline and optimized LN, cost of including an adhoc route, equipment utilization along various routes, a number of loaded and empty trips, as well as total number of trips for baseline and optimized LN. In an example embodiment, demand volume (i.e., number of shipments), and maximum demand capacity may be also output by shipment delivery system 320. In various exemplary embodiments, results may be presented via one or more interfaces 340 that may be configured to compare various metrics for baseline and optimized LN.

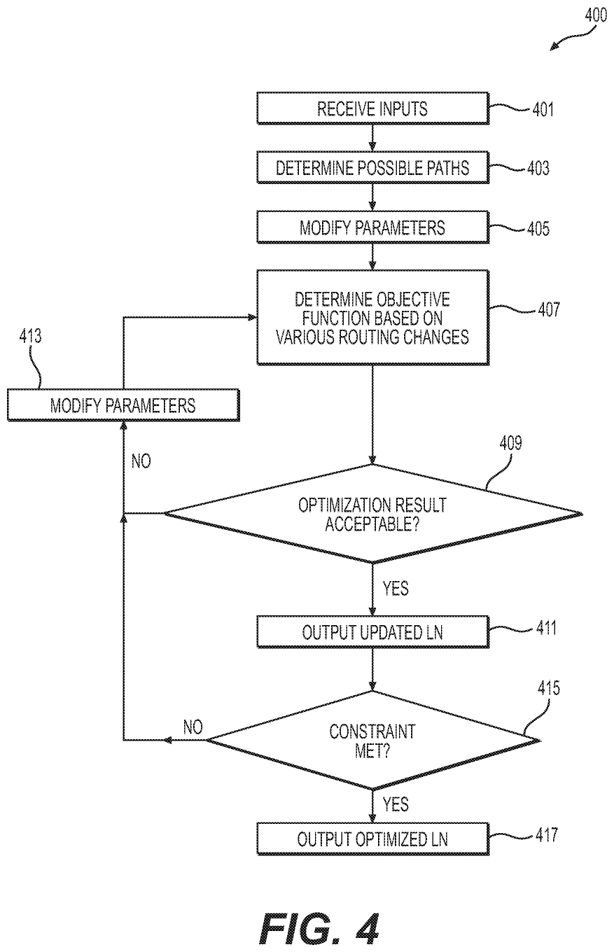

FIG. 4 shows an embodiment of an exemplary process 400 for optimizing LN 100 consistent with disclosed embodiments. The order and arrangement of steps of process 400 is provided for purposes of illustration. As will be appreciated from this disclosure, modifications may be made to process 400 by, for example, adding, combining, removing, and/or rearranging the steps of process 400. It will be understood that one or more steps of process 400 may be executed by one or more processors associated with shipment delivery system 320.

Process 400 may include a step 401 of receiving inputs. The inputs may include, for example, information associated with a configuration of baseline line haul network 100. By way of example, at step 401 shipment delivery system 320 (as shown in FIG. 3) may receive inputs 310 (as shown in FIG. 3), including for example, one or more parameters associated with volume data 311, locations data 312, equipment data 313, route data 314, baseline route data 315, and user defined parameters 316 associated with the baseline line haul network 100. It is also contemplated that in step 401, shipment delivery system 320 may also receive one or more constraints 321.

Process 400 may include a step 403 of determining possible paths for transporting demand 130D from origin 110 to destination 116. For example, at step 403 of process 400, shipment delivery system 320 may be configured to determine the possible paths for OD pair (e.g. origin 110, destination 116). By way of example, at step 401 system 320 may receive a set of routes available to baseline line haul network LN 100. At step 403, system 320 may construct possible combinations of routes that may form one or more paths starting at origin 110 and finishing at destination 116. In various exemplary embodiments, one or more paths (e.g. 130-131, 130-132, 134, etc.) obtained at step 403 may be scheduled paths available for the baseline LN. System 320 may also generate one or more new scheduled paths not used for the baseline LN. For example, the one or more new scheduled paths may include routes that may be currently used for a different LN. Additionally, in step 403, system 320 may determine one or more alternate paths for OD pair (e.g. between origin 110 and destination 116) that contain one or more adhoc routes.

Process 400 may include step 405 of modifying one or more parameters associated with the baseline line haul network. In various exemplary embodiments, shipment delivery system 320 may modify one or more parameters associated with the baseline line haul network (e.g. LN 100). For example, shipment delivery system 320 may select a set of routing changes (e.g., some paths from the set of new scheduled paths and at most one path from the few adhoc paths) that may be used for optimizing LN. By way of another example, for each route forming scheduled/adhoc paths, system 320 may assign one or more equipment units (e.g. vehicle 143) for transporting a demand for an OD pair. For example, referring to routes and paths shown in FIG. 2, system 320 may assign equipment 130E for transporting demand 130D along route 130, and equipment 131E for transporting demand 131D (which equals to the demand 130D) along route 131. Alternatively, demand 130D may be transported along path 134, and be assigned to equipment 134E.

Process 400 may include a step 407 of determining an objective function (also referred to as a cost function) that indicates the overall measure of the cost of the LN (e.g. LN 100). By way of example, the type of equipment along routes 130, 131 and 134 as well as the amount of demand 130D may constitute path related parameters that may affect an overall cost of LN 100. These path-related parameters may be used at step 405 of process 400 for calculating the objective function. In an example embodiment, the objective function may be composed of two terms: the first term related to the total cost of equipment on scheduled routes (e.g. scheduled cost) and the second term related to the cost of dispatching an adhoc route (e.g. adhoc cost). For example, shipment delivery system 320 may determine a scheduled cost of transporting a portion of shipments (e.g. a portion of the demand) via one or more scheduled paths, and an adhoc cost of transporting the remainder of the shipments (e.g. remaining portion of the demand) via one or more alternate paths, which may include one or more adhoc routes. In some embodiments, the objective function may be a cumulative cost of operating LN 100 for a given duration of time (e.g., days, weeks, months or years). For example, in step 405, shipment delivery system 320 may evaluate a baseline cost of operating the baseline line haul network. Shipment delivery system 320 may also evaluate a cost of operating a line haul network that includes, for example, routing changes made to the baseline line haul network. In other exemplary embodiments, the objective function may additionally or alternatively include other parameters associated with the baseline or optimized line haul network. For example, the objective function may additionally or alternatively include a service level achieved by the baseline and/or optimized line haul networks.

Process 400 may include step 409 of determining whether the optimization result obtained, for example, in step 407 is acceptable. By way of example, at step 409 of process 400, the change in the objective function (decrease in the value of the objective function) due to various routing changes may be compared with a predetermined target decrease value (e.g., target decrease value may be 5% of the cost or target increase value may be 5% increase in service level). For example, shipment delivery system may determine a change in cost between the baseline cost and the cost of the modified line haul network determined in, for example, step 407. If a decrease in the objective function (e.g. cost) is equal to or more than a target decrease value, or if an increase in the objective function (e.g. service level) is equal to or greater than a target increase value (step 409, Yes), shipment delivery system 320 may output the modified LN as an updated LN (i.e., output found routes and related equipment for the found routes) at step 411. If the change in the objective function, however, is not acceptable (step 409, No), shipment delivery system 320 may proceed to step 413. It is contemplated that in some exemplary embodiments, instead of evaluating a decrease or increase in value, shipment delivery system may compare the cost and/or service level associated with a line haul network with a target cost and/or target service level. By way of example, in step 409, shipment delivery system may evaluate whether the service level obtained using the modified parameters exceeds a target service level.

In step 413, shipment delivery system 320 may modify one or more additional parameters associated with the baseline line haul network. For example, shipment delivery system 320 may modify path-related parameters affecting the overall cost of the LN at step 411 and proceed in re-evaluating objective function at step 407. In step 413, shipment delivery system 320 may vary any number of parameters associated with the line haul network. For example, shipment delivery system 320 may select one or more alternate paths including one or more adhoc routes between the origin or destination. Additionally or alternatively, shipment delivery system by remove or add a scheduled path from the line haul network or add or remove equipment to/from one or more of the scheduled or alternate paths. By way of example, system 320 may unassign at least one scheduled equipment unit from at least one of the scheduled paths; unassign at least one adhoc equipment unit from the alternate path; assign the at least one scheduled equipment unit to a new scheduled path different from the at least one scheduled path; and/or assign the at least one adhoc equipment unit to a new alternate path different from the alternate path. It is contemplated that in step 413, shipment delivery system 320 may change any number of parameters associated with, for example, volume data 311, locations data 312, equipment data 313, route data 314, and/or baseline route data 315.

It should be noted that information about routes and related equipment may not be sufficient information to characterize LN. For example, an equipment departure time may be an important parameter (e.g., equipment traveling at nighttime may have lower operational costs when compared to the same type of equipment traveling during daytime).

It is contemplated that shipment delivery system 320 may perform optimization of a line haul network incrementally. For example, after outputting an updated line haul network in step 411, shipment delivery system 320 may proceed to step 415 to determine whether one or more constraints have been met. By way of example, shipment delivery system 320 may receive a constraint specifying a maximum number of modifications that may be made to the baseline line haul network in step 401. In step 415, system 320 may determine whether the number of parameters of baseline line haul network that have been modified, for example, in previously executed steps 405, 407, and 413 exceeds the maximum number of modifications. If the number of modifications is equal to the maximum number of modifications (Step 415: Yes), system 320 may proceed to step 417 of outputting the updated line haul network as the optimized line haul network. If the number of modifications is less than the maximum number of modifications, system 320 may proceed to step 413. In step 413, system 320 may modify one or more parameters of the updated set of parameters associated with the updated line haul network output in, for example, step 411. Thus, by repeatedly and sequentially executing steps 407, 409, 411, 415, and 413, system 320 may make incremental modifications to the baseline line haul network. It will be understood that the above description of constraints in the form of a maximum number of allowable modifications is exemplary and other types of constraints, for example, described above with respect to item 321 of FIG. 3 are also contemplated.

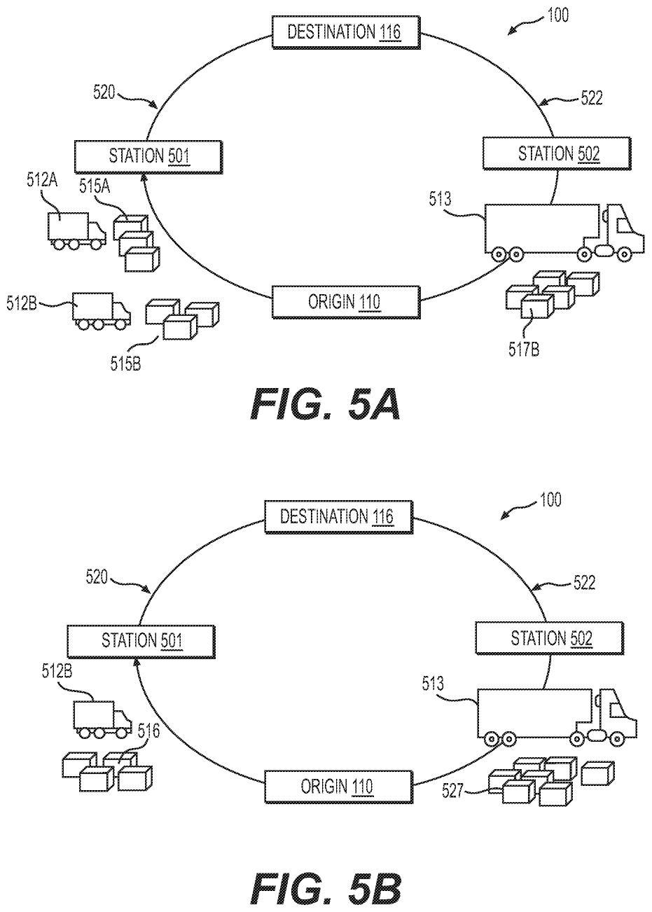

FIG. 5A illustrates an exemplary LN 100. In FIG. 5A equipment units 512A and 512B are used to transport demand 515A and 515B along first path 520 passing through station 501. Similarly, equipment unit 513 may be used to transport demand 517 along second path 522 passing through station 502. In an example embodiment, equipment unit 513 may be a large truck whereas equipment units 512A and 512B may be smaller vehicles. In one exemplary embodiment, unit 513 may not be completely utilized. For example, unit 513 may be utilized by 60% and units 512A and 512B may be utilized by 70% percent.

Shipment delivery system 320 may optimize LN 100. FIG. 5B illustrates an exemplary optimized LN 100. As illustrated in FIG. 5B, optimized LN 100 may include one vehicle (equipment unit 512B) traveling along first path 520 as shown in FIG. 5B. For an optimized configuration of LN 100, unit 512B may have a new demand 516, as shown in FIG. 5B that may include a portion of demand 515A previously transported by unit 512A. In an example embodiment, demand 516 may be larger than 512B and may result in higher levels of utilization for unit 512B. Similarly, another portion of demand 515A may be transported by unit 513 via second path 522, resulting in an overall demand 527 (shown in FIG. 5B) for unit 513 that may be higher than previously transported demand 517 by unit 513. By optimizing LN 100, the cost associated with unit 512A may be reduced or eliminated, reducing the overall cost of LN.

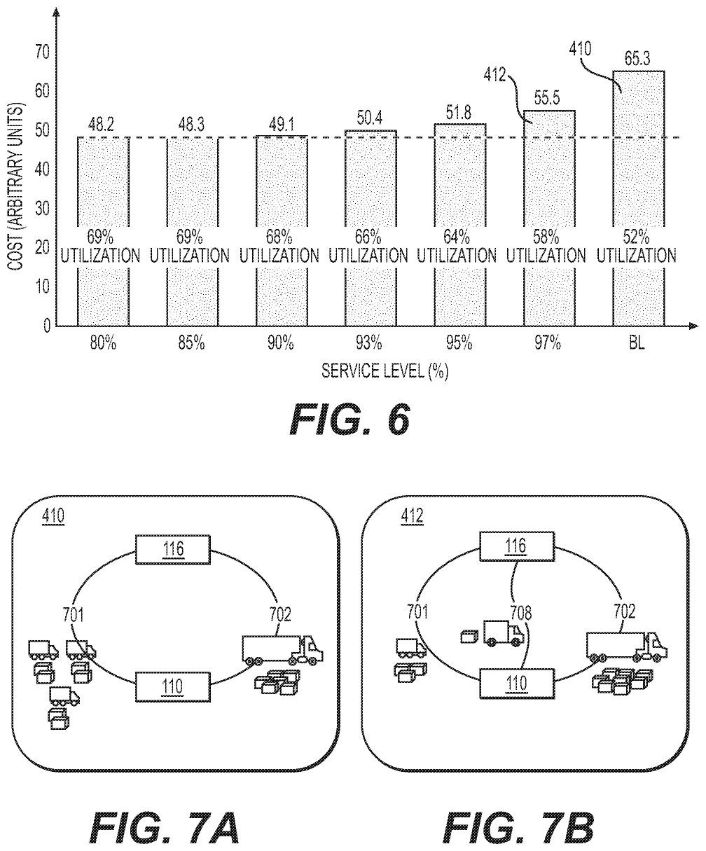

FIG. 6 illustrates an exemplary chart showing changes in the overall cost of LN 100 with increased utilization of equipment and with a decrease in service level. For example, when service level is 100% as shown by a baseline LN 410 (i.e., all the packages are delivered prior to the committed delivery time), the cost is 65.3 (arbitrary units). By slightly reducing commitment to a perfect service level (e.g., reducing service level by 3%, resulting in service level of 97%) by using, for example, an adhoc route, the overall operational cost may be reduced significantly (e.g., by 9.8 to 55.5 arbitrary units), as shown by an optimized LN 412, resulting in overall drop in cost of about 15%. As also illustrated by FIG. 6, further reduction in service level (e.g., reducing service level by another 4% to 93%) may not lead to a significant reduction in cost (e.g., reduction in cost may be an additional 4.1 units or 7% measured relative to the original cost).

FIGS. 7A and 7B illustrate an optimization process for LN that may be performed by shipment delivery system 320 with reference to FIG. 6. For example, FIG. 7A shows LN 410 that uses two paths 701 and 702 for transporting demand from origin 110 to destination 116. In FIG. 7A three equipment units are used for path 701 and one large capacity equipment unit is used for path 702. FIG. 7B shows optimized LN 412 where only one equipment unit is used for path 701 resulting in significant cost savings. FIG. 7B shows that adding an alternate path 708, which may include one or more adhoc routes, may allow delivery of shipments from origin 110 to destination 116 at an overall cost saving for LN 412.

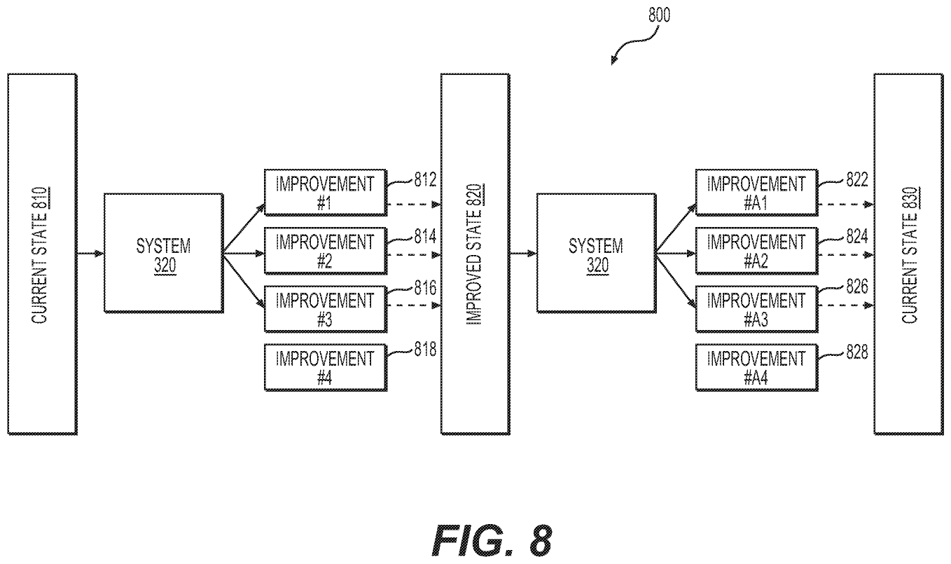

FIG. 8 illustrates a process 800 of identifying and using various incremental improvements for optimizing a LN that may be performed by shipment delivery system 320. By way of example and as illustrated in FIG. 8, process 800 may begin from a baseline LN 810 (e.g., current state). Process 800 may include operating shipment delivery system 320, which may generate, for example, improvements 812-818 (e.g., improvements 1 through 4 as shown). Improvements 812-818 may include one or more modifications to LN 810, such as, using different equipment, using one or more adhoc paths, redistributing the demand to existing or new equipment travelling on the one or more scheduled or adhoc paths, etc. One or more improvements 812-818 may be selected by a user (e.g., an engineer or a LN planner) to make an incremental optimization of LN 810. For example, the user may select one of improvements 812-818, which may result in LN 820. It is contemplated that in some exemplary embodiments, shipment delivery system 320 may automatically select one of the improvements 812-818.

Process 800 may include operating shipment delivery system 320 beginning from incrementally improved LN 820 (e.g. updated line haul network or modified line haul network). Shipment delivery system 320 may generate, for example, improvements 822-828 (e.g., improvements A1 through A4 as illustrated in FIG. 8). Improvements 822-828 may include one or more modifications to LN 820, such as, using different equipment, using one or more adhoc paths, redistributing the demand to existing or new equipment travelling on the one or more scheduled or adhoc paths, etc. One or more improvements 822-828 may be selected by the user or automatically by shipment delivery system 320 to make an incremental optimization of LN 820. For example, the user or shipment delivery system 320 may select one of improvements 822-828, which may result in incrementally optimized LN 830 (e.g. further updated line haul network or optimized line haul network). The above described process may be repeated multiple times to obtain incremental improvements to a LN.

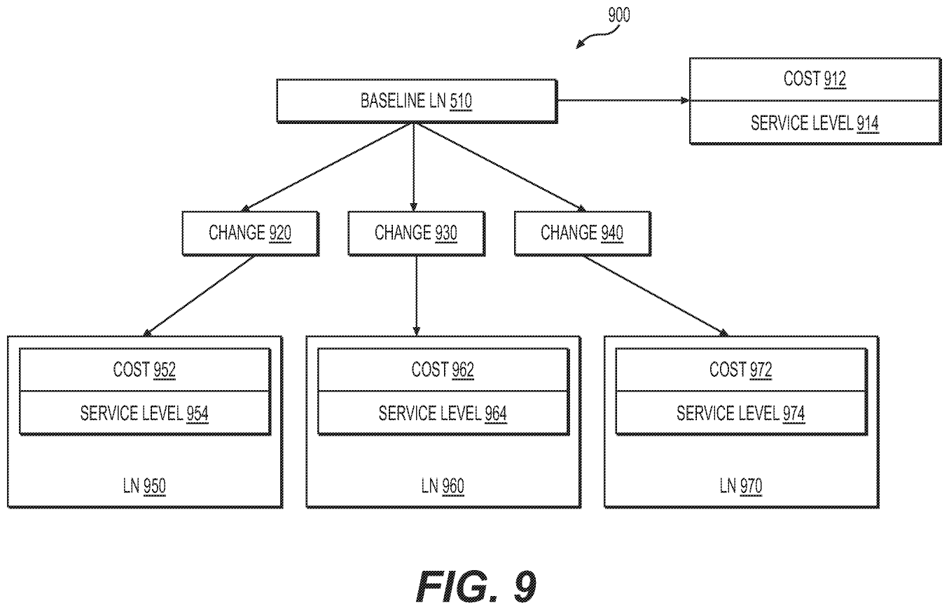

FIG. 9 illustrates another exemplary process 900 of optimizing a LN that may be performed by shipment delivery system 320. At the beginning of process 900, shipment delivery system 320 may receive baseline LN 910, which may include an associated cost 912 (e.g., as measured by an objective function calculated for LN 901) and associated service level 914. In one exemplary embodiment, a change 920 to baseline LN 901 may lead to modified LN 950, which may include an associated cost 952 and an associated service level 954; a change 930 may lead to modified LN 960, which may include an associated cost 962 and an associated service level 964; and change 940 may lead to modified LN 970, which may include an associated cost 972 and an associated service level 974. In some exemplary embodiments, one or more optimization constraints for LN 910 may require the service level for LN 910 to be higher than a required minimum value. For instance, service levels 954 and 964 may be higher than the required minimum value, and service level 974 may be lower than the required minimum value. If for the above-described case, cost 962 is lower than cost 952, then shipment delivery system 320 may be configured to select change 930 as the best change for optimizing LN 910.

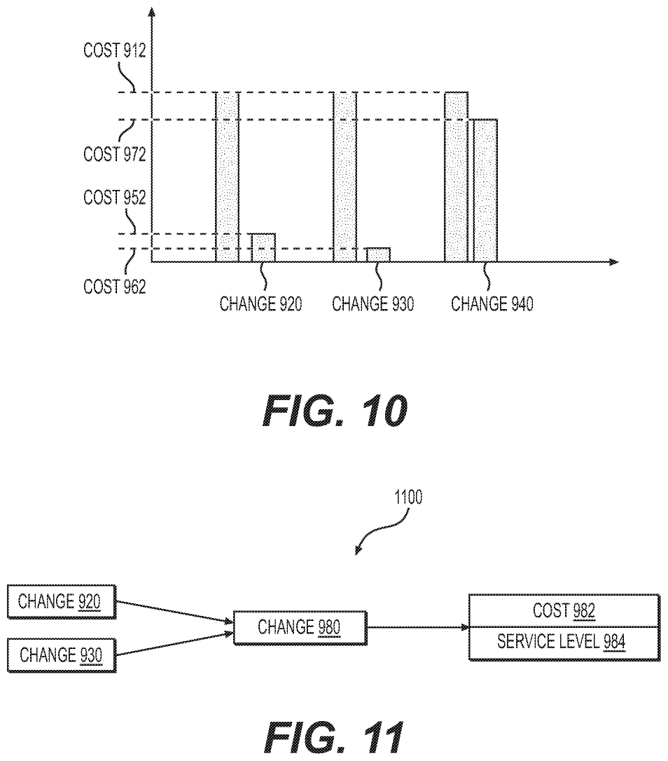

FIG. 10 illustrates an exemplary chart showing costs 952, 962, and 972 for changes 920, 930, 940, respectively, as described in FIG. 9. In an example embodiment, costs 952 and 962 may be the acceptably small costs, and 972 may be an unacceptably high cost. Shipment delivery system 320 may recommend selecting change 930 associated with the smallest cost 962.

FIG. 11 illustrates an exemplary process 1100 in which changes 920 and 930 may be combined (in some cases) to form a change 980 that may lead to further cost reduction. For example, change 980 may be associated with cost 982 and service level 984, in which cost 982 may be lower that cost 962 achieved by change 930 alone. Shipment delivery system 320 may provide results for combinations of various changes such as a combination of changes 920 and 930. In various embodiments, a genetic algorithm may be used for solving the constrained optimization problem related to minimizing the objective function subject to minimum target service levels.

In various embodiments, shipment delivery system 320 may obtain a set of optimized baseline LN configurations for various values of demand between OD pair. For example, demand may be a predictable function of events happening throughout the year (e.g., a demand during holidays may be predictably higher than a regular demand). For such predictable values of the demand, shipment delivery system 320 may obtain optimized LN configurations and store the optimized LN configurations in a database. In various embodiments, when the demand experiences sufficient changes, shipment delivery system 320 may retrieve an appropriate configuration for the optimized LN that matches the currently required demand. Additionally, or alternatively, shipment delivery system 320 may obtain a set of optimized baseline LN configurations for various changes in demand between OD pair. For example, if current demand is D₁, demand predicted in a month is D₂ and demand predicted in a half a year is D₃ a set of baseline LNs, LN₁, LN₂, and LN₃ may be calculated corresponding to each demand D₁, D₂, and D₃. However, if demand predicted in a month is D₄ and demand predicted in a half a year is D₃ a set of different baseline LNs, LN₁, LN₄, and LN₅ may be calculated, where LN₄ may be not equal to LN₂ and LN₅ may be not equal to LN₃. The reason for the fact that LN₅ may be not equal to LN₃ is because LN may not strictly be a function of the demand, but may also be a function on how the demand changes with time, that is LN₅=LN₅(D₄, D₃).

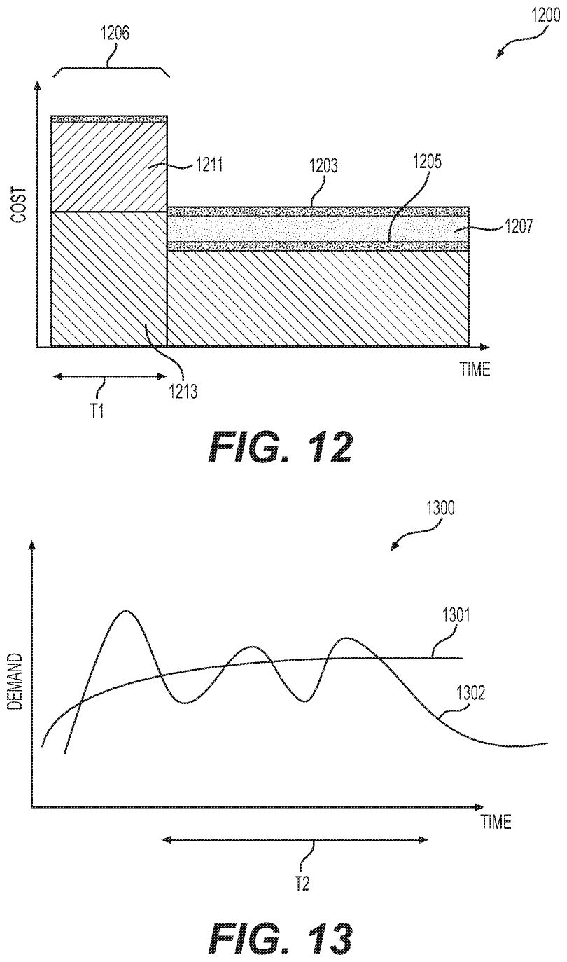

FIG. 12 illustrates an exemplary chart 1200 that shows costs associated with updating LN due to routing changes as a result of optimization of LN. Shipment delivery system 320 may determine the various costs illustrated in FIG. 12 and provide that information with analysis 330. As illustrated in FIG. 12, an incremental cost 1203 may be associated with operating LN prior to optimization and an incremental cost 1205 may be associated with operating LN after LN has been optimized. Incremental cost 1205 may be lower than incremental cost 1203 due to optimization of LN. The cumulative cost as a function of time for both the unoptimized and the optimized LNs is shown by areas under respective lines representing incremental costs 1203 and 1205, respectively. As seen in FIG. 12, a difference in cumulative costs between non-optimized LN and optimized LN may be represented by an area 1207. It will be understood that this cumulative cost may increase with time. FIG. 12 also shows a region 1206 corresponding to an interval of time T1 during which updates to LN are introduced (updates may include routing changes, equipment changes, etc. and may require days, weeks or month to be implemented) in order to optimize LN. During time T1 in which such updates are introduced, LN may still be in a non-optimized state characterized by an incremental cost 1203. In addition to cost 1203, a cumulative cost associated with carrying out the update to LN may be significant, as shown in FIG. 12 by a cumulative cost represented by an area 1211. Examining FIG. 12, it may be seen that the cost savings associated with optimizing LN can be obtained as a difference between area 1207 and area 1211. For a short duration of time, when area 1207 is smaller than area 1211 the cost savings associated with optimizing LN may not compensate for the costs associated with optimizing LN. Over a longer duration of time, however, the cost savings associated with optimizing LN may be larger than costs associated with optimizing LN. Thus optimization of LN may be useful over an extended period of time.

Shipment delivery system 320 may determine whether or not optimization of LN is useful depending on variations in demand. For example, FIG. 13 shows an exemplary chart 1300 of demand as a function of time. As illustrated in FIG. 13, demand 1301 may be a slowly varying function of time, whereas demand 1302 may be a volatile function of time. When demand does not vary significantly (e.g., demand 1301) over a time scale T2 that may be a time interval over which difference between area 1207 and area 1211 is zero, optimization of LN may lead to overall cost savings. However, when demand varies significantly over the time scale T2 (e.g., demand 1302), then optimization of LN may not necessarily lead to the overall cost savings.

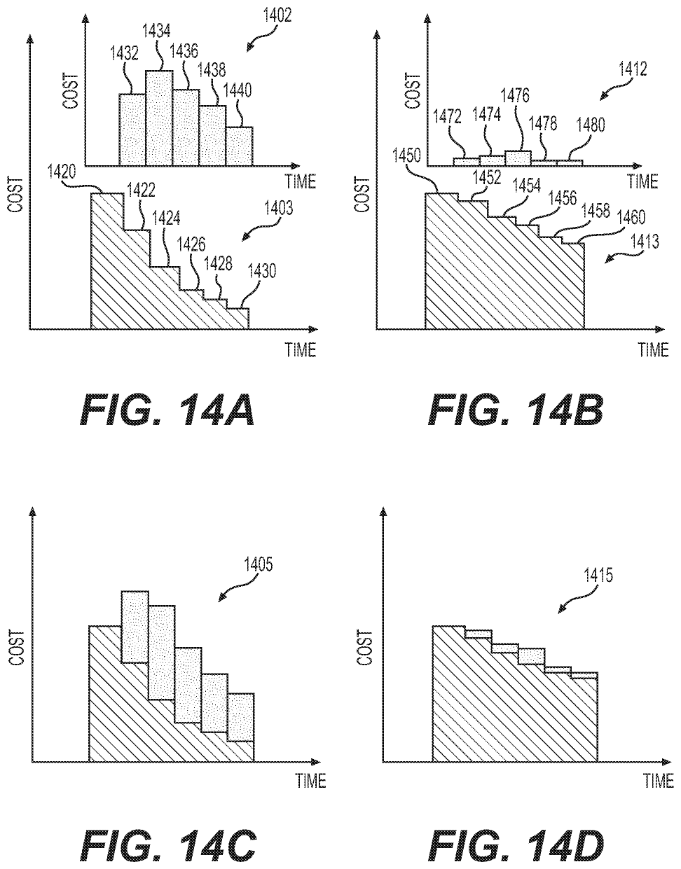

FIGS. 14A-D illustrate exemplary charts used to show the impact of the costs associated with making aggressive changes to an existing LN. For example, FIGS. 14A-D indicate that while cost reduction for optimized LN associated with aggressive incremental optimization may be significant (e.g., region 1403 indicates such cost reduction), a combined cost of LN and a cost associated with the aggressive incremental optimization for LN may be larger than equivalent cost when incremental optimization is less aggressive (i.e., mild incremental optimization). FIG. 14A shows, for example, costs 1402 associated with the aggressive optimization. Aggressive optimization may be related to a large number of routing changes, significant changes in equipment used for LN and the like. FIG. 14A also illustrates the reduction in cost of operating a LN obtained due to the aggressive optimization. For example, beginning with a baseline cost 1420, making incremental changes as illustrated by costs 1402 may incur costs 1432-1440. These same changes may provide incrementally optimized LNs having operating costs 1422-1430, respectively. Thus, for example making an incremental change having cost 1432 may produce an incrementally optimized LN having an operating cost 1422. Similarly, for example, making an incremental change having cost 1434 may produce an incrementally optimized LN having an operating cost 1424, and so on.

FIG. 14B illustrates a scenario where the incremental optimization is not as aggressive. Such a mild incremental optimization may include, for example, a small number of routing changes, few equipment changes, etc. As illustrated in FIG. 14B, making milder incremental changes as illustrated by costs 1412 may incur costs 1472-1480. These same changes may provide incrementally optimized LNs having operating costs 1452-1460, respectively. Thus, for example, starting from a baseline cost of 1420, making an incremental modification costing 1472 may yield an incrementally optimized LN having an operating cost 1452, which may be lower than 1420. Similarly, making a further incremental modification costing 1474 may yield an incrementally optimized LN having an operating cost 1454 which may be lower than 1452, and so on.

FIGS. 14C and 14D show combined costs 1405 and 1415 respectively for the aggressive incremental optimization and the mild incremental optimization, respectively. In some exemplary embodiments as illustrated in FIGS. 14C and 14D, total cost 1405 may exceed cost 1415. Thus, FIGS. 14A-14D show that both cost savings (e.g. 1403) and costs associated with optimization (e.g. 1402) should be taken into account when considering the overall cost for optimizing LN. In various exemplary embodiments, shipment delivery system 320 may be configured to estimate the combined cost (e.g., cost 1405 and 1415) by estimating the cost savings (e.g., cost savings 1403 and 1413) as well as the costs related to the processing of optimizing LN (e.g., costs 1402 and 1412).

It is contemplated that shipment delivery system 320 may include many different types of models. In some exemplary embodiments, shipment delivery system 320 may include linear optimization model 1501 and rule-based model 1503. Linear optimization model 1501 may include an optimization model based on optimizing an objective function, similar to the description of system 320 provided above with respect to FIGS. 3 and 4.

In various exemplary embodiments, rule-based model 1503 may be a model that is based on computer-implemented rules. For example, rule-based model 1503 may include a computer-implemented rule of identifying a first equipment unit transporting a first shipment along a path from origin 110 to destination 116 (as shown for example in FIG. 2), identifying other equipment units transporting shipments from origin 110 to destination 116, the other equipment units having incomplete utilization, and distributing the first demand between the other equipment units to allow for elimination of the first equipment unit.

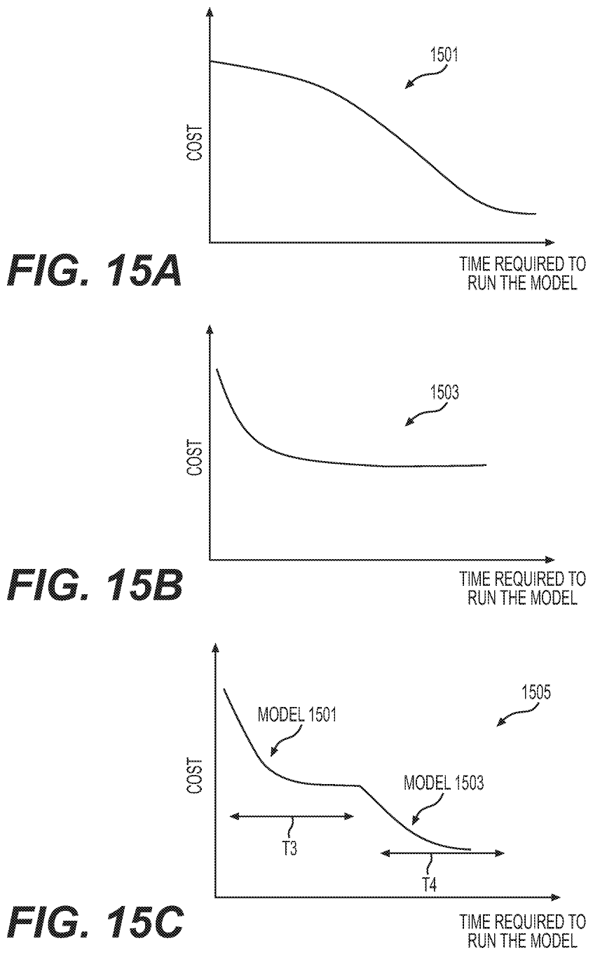

Optimizing LN may be a computationally intensive process. FIGS. 15A-15CC illustrate how a cost of LN (e.g., measured using an objective function) may be reduced as a function of the time required to run a respective model. For example, as illustrated in FIG. 15A, for linear optimization model 1501 the cost of LN (i.e., the value of the objective function) may initially change slowly as a function of processing time. In contrast as illustrated in FIG. 15B, for rule-based model 1503, the cost may initially decrease rapidly as a function of processing time. FIG. 15C illustrates how the cost of LN may change when running a combined model. By way of example, as illustrated in FIG. 15C, combined model 1505 may include using model 1501 for a duration of time T3 and following that with model 1503 for a duration of time T4. As illustrated in FIG. 15C, running such a combined model may help improve the overall decrease in cost as a function of processing time as compared to decreases in cost obtained using model 1501 or model 1503 alone.

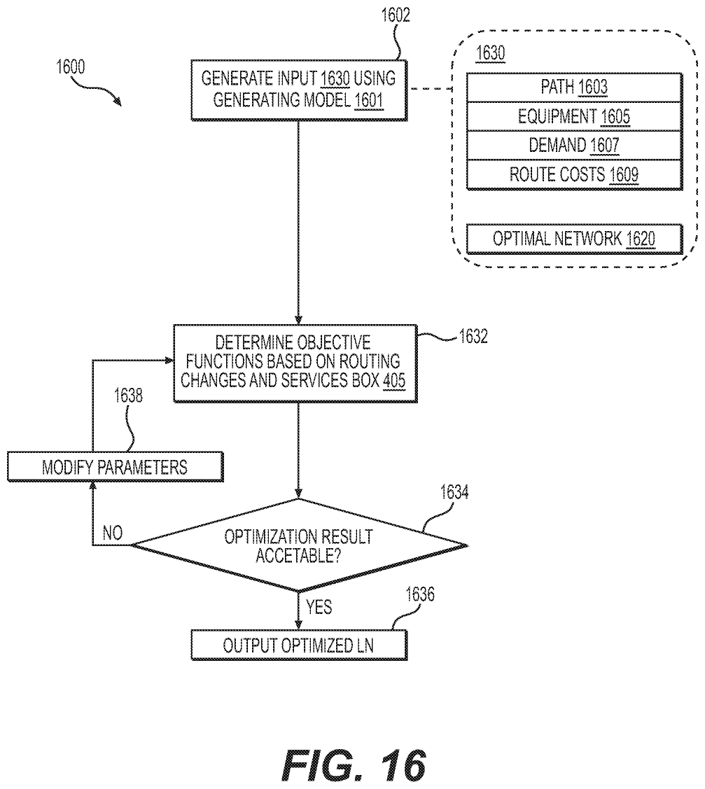

FIG. 16 shows an exemplary process 1600 for optimizing a LN based on generated information 1630 associated with a fictitious baseline LN. The order and arrangement of steps of process 1600 is provided for purposes of illustration. As will be appreciated from this disclosure, modifications may be made to process 1600 by, for example, adding, combining, removing, and/or rearranging the steps of process 1600. It will be understood that one or more steps of process 1600 may be executed by one or more processors associated with shipment delivery system 320.

As illustrated in FIG. 16, process 1600 may include a step 1602 of generating a fictitious LN. For example, in step 1602, LN generating model 1601 may be used to generate information 1630 associated with a fictitious LN that may include fictitious paths 1603 (e.g., fictitious routes, paths, stations, etc.) fictitious equipment 1605 (e.g., a number of equipment units, equipment types, etc.) fictitious demand 1607, and fictitious route related costs 1609. Additionally, in step 1602 LN generating model 1601 may generate an optimized LN 1620 based on, for example, a subset of or all of paths 1603 using some or all of equipment 1605, for demand 1607, and costs 1609. In an example embodiment, optimized LN 1620 may be generate using a different shipment delivery system (e.g. 320) or may be obtained based on the experience of a LN planner.

Process 1600 may include a step 1632 of receiving information 1630 associated with a fictitious LN model. By way of example, in step 1632 shipment delivery system 320 may receive information 1630 and may generate an optimized LN based on shipment delivery system 320. For example, in step 1632, shipment delivery system 320 may perform operations similar to operations performed in, for example, step 405 of process 400.

Process 1600 may include step 1634 of evaluating the optimized LN generated, for example, in step 1632. In step 1634, shipment delivery system 320 may perform operations similar to those discussed above, for example, in step 407 of process 400. that can be evaluated at step 1634 of process 1600. When the results (e.g. cost) of an optimized LN is acceptable (step 1634, Yes), process 1600 may proceed to step 1636 of outputting the optimized LN. Alternatively, when the result of the optimized LN is unacceptable (step 1634, No), process 1600 may proceed to step 1638 of modifying the parameters used in shipment delivery system 320. In step 1638, process 1600 may include operations similar to those performed at, for example, step 411 of process 400. For example, when system 320 is a neural network, parameters associated with weights of neural network may be adjusted. In various embodiments, process 1600 may be an iterative process for adjusting parameters of shipment delivery system 320.

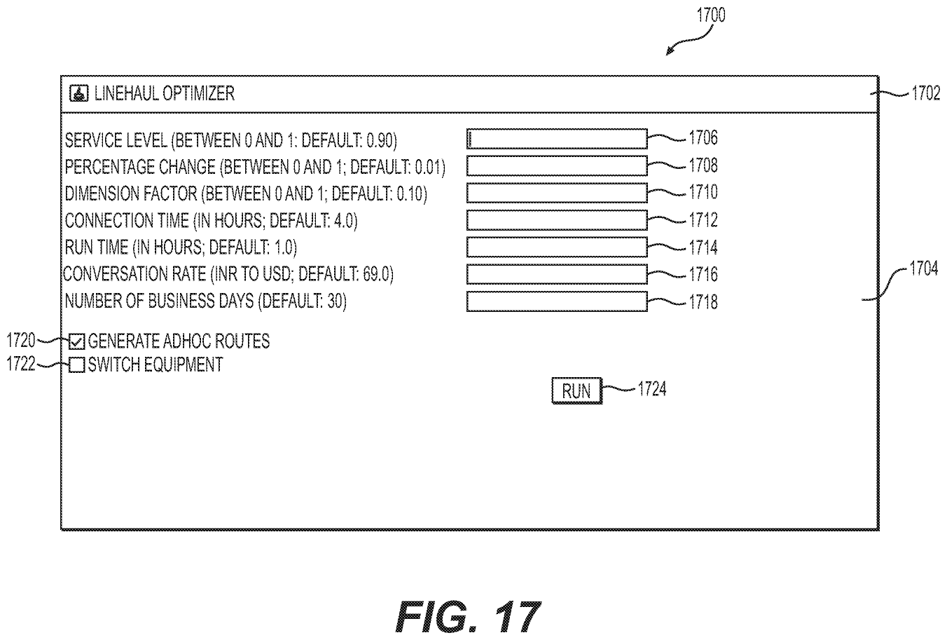

FIGS. 17-21 illustrate various exemplary interfaces 340 (see FIG. 3) associated with shipment delivery system 320. Interfaces 340 may include, for example, graphical user interfaces. For example, FIG. 17 shows an exemplary interface 1700 that may allow a user such as a LN planner to input various constraints 321 that may be used for optimizing LN. Interface 1700 may include a title area 1702 and an information area 1704. Information area 1704 of interface 1700 may include a number of text boxes for receiving user inputs, for example, constraints 321. In one exemplary embodiment as illustrated in FIG. 17, information area may include, for example, text boxes for a minimum service level 1706, percentage change 1708, dimension factor 1710, connection time 1712, run time 1714, currency conversion rate 1716, number of business days 1718, etc. In addition, interface 1700 may allow a user to specify whether to generate adhoc routes or switch equipment, via check boxes 1720 and 1722, respectively. Interface 1700 may also include a widget, for example, button 1724, which when executed (e.g. clicked, pushed, etc.) by the user may start optimizing the LN based on the inputs provided in boxes 1706-1722. and the like as described above. Although graphical elements such as text boxes 1706-1718, check boxes 1720, 1722, and button 1724 have been described above, it is contemplated that interface 1700 may receive inputs from the user via other types of graphical elements, such as, pull-down menus, sliders, radio buttons, dials, switches, etc. It should be noted that the listing of inputs 1706-1722 illustrated in FIG. 17 is exemplary and any other suitable inputs required by shipment delivery system 320 may be obtained via interface 1700.

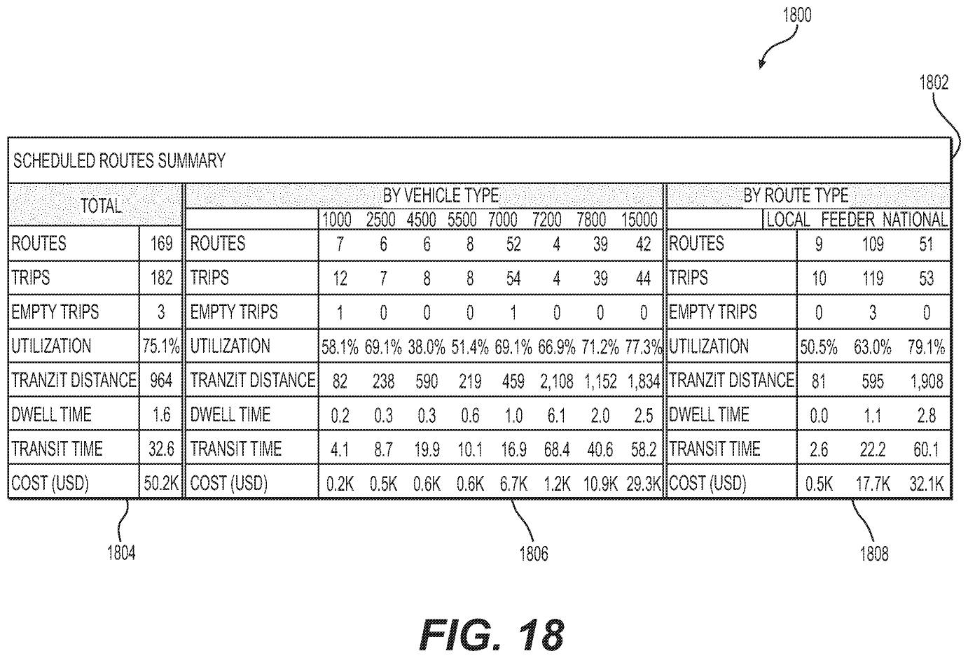

FIG. 18 shows an exemplary interface 1800 for presenting information related to scheduled routes. Interface 1800 may include title area 1802, summary total area 1804, summary by equipment area 1806, and summary by route area 1808. As illustrated in FIG. 18, title area 1802 may include a title representative of the information presented in interface 1800. Summary total area 1804 may display information summarizing the totals for various parameters, for example, total number of routes in the LN, total number of trips taken by equipment in the LN, number of trips where equipment was empty, overall utilization rate for the LN, total distance traveled by various equipment in the LN, total transit time and/or cost associated with the LN, etc. Summary by equipment area 1806 may display information regarding, for example, routes, trips, empty trips, utilization, transit distance, transit time, cost, etc. for each type of equipment. Thus, for example area 1806 may include a column with information for equipment types represented by the identifiers 1000, 2500, etc. In summary by route area 1808, the same type of information may be grouped by a type of route, for example, a local route (e.g. city street), a feeder route (e.g. state or county road), or a national route (e.g. interstate highway). grouped by total routes, routes for each equipment type (equipment may be classified by the amount of weight that can be transported by the equipment) or by route type (route type may affect the cost of the route). It should be noted that the groupings and items of information illustrated in FIG. 18 are exemplary and any other suitable information about scheduled routes may be displayed on interface 1800 based on the data generated by shipment delivery system 320.

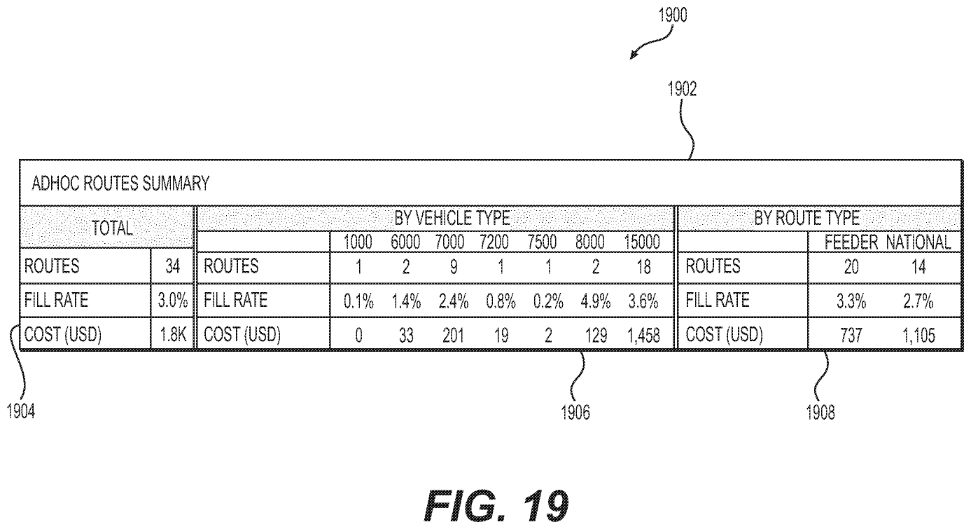

FIG. 19 shows an exemplary interface 1900 for presenting information related to scheduled routes. Interface 1900 may include title area 1902, summary total area 1904, summary by equipment area 1906, and summary by route area 1908. As illustrated in FIG. 19 interface 1900 may include information for adhoc routes similar to the information discussed above for scheduled rights with respect to interface 1800 of FIG. 18. It should be noted that the groupings and items of information illustrated in FIG. 19 are exemplary and any other suitable information about adhoc routes may be displayed for the user based on the data generated by shipment delivery system 320.

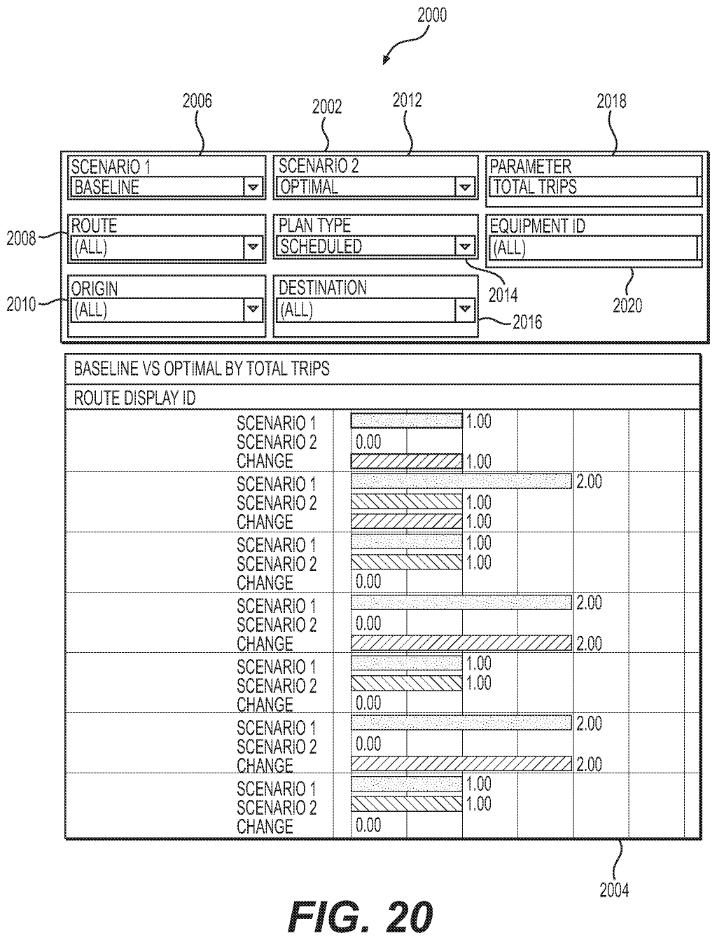

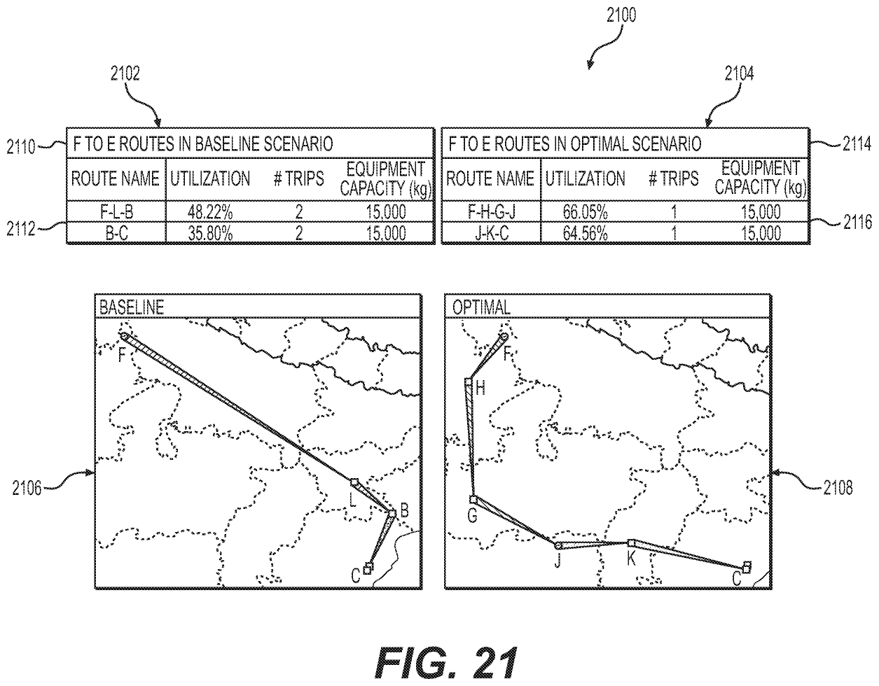

FIG. 20 shows an exemplary interface 2000 for comparing information related to a baseline LN and an optimized LN. Interface 2000 may include a selector area 2002 and a results area 2004. In one exemplary embodiment as illustrated in FIG. 20, selector area 2002 may include one or more pull-down menus 2006-2020. A user, for example, a LN planner may use the pull-down menus to make desired selections. Results area 2004 may display information associated with the selection made in one or more of pull-down menus 2006-2020. By way of example, a user may select “Baseline” in pull-down menu 2006, “Optimal” in pull-down menu 2012, “Scheduled” in pull-down menu 2014, and the parameter “Total Trips” in pull-down menu 2018. In response results area 2004 may display a comparison between the total number of trips associated with the baseline LN and the optimized LN for a plurality of routes. As also illustrated in FIG. 20, results area 2004 may also display a difference between the baseline and optimized LNs for each route. In some exemplary embodiments as illustrated in FIG. 20, the information may be in the form of a bar chart, which may display the information in a plurality of colors based on the magnitude of the values associated with each displayed item. It is contemplated that interface 2000 may use other types of displays including, for example, pie charts, graphs, scatter plots, etc. It should be noted that the number and types of pull-down menus and the information displayed in results area 2004 as illustrated in FIG. 20 are exemplary and any other type of graphical widgets (e.g. buttons, control boxes, check boxes, etc.) and/or any other type of suitable information comparing the baseline and optimized LN may be displayed in interface 2000 based on the data generated by shipment delivery system 320.

FIG. 21 shows another exemplary interface 2100 for comparing information related to a baseline LN and an optimized LN. Interface 2100 may include a baseline LN area 2102, optimized LN area 2104, baseline LN map area 2106, and optimized LN map area 2108. In one exemplary embodiment as illustrated in FIG. 21, each of baseline LN area 2102 and optimized LN area 2104 may include title areas 2110 and 2114, respectively. Title areas 2110 and 2114 may display titles associated with baseline LN and optimized LN, respectively. Each of baseline LN area 2102 and optimized LN area 2104 may also include information areas 2112 and 2116, respectively. Information area 2112 may display information associated with baseline LN. For example, a path from an origin F to a destination C for baseline LN may include route F-L-B, and route B-C. For the optimized LN the routes may be different and may include a route F-H-G-J and a route J-K-C, which may be displayed in information area 2116. In one exemplary embodiment as illustrated in FIG. 21, information areas 2112 and 2116 may display information including, for example, utilization rates, number of trips, and equipment capacity used in each of routes F-L-B, B-C, F-H-G-J, and J-K-C. As illustrated in FIG. 21, for example, utilization for optimized LN may be significantly improved (average utilization of about 65% for the optimized LN compared to the average utilization of about 42% for the baseline LN). Selecting any particular route, for example, F-L-B on information area 2112 or F-H-G-J on information area 2116 may display maps associated with the routes in information areas 2112, 2116 in map areas 2106, 2108, respectively. It should be noted that the types of information displayed in interface 2100 are exemplary and any other types of information and or graphical display associated with baseline LN and optimized LN may be displayed in interface 2100 based on the data generated by shipment delivery system 320.

Although embodiments of the computer-based method relate specifically to linehaul operations using LN, the framework disclosed here may be adapted and modified for various types of linehaul operations. The efficiency gains are quantified in terms of reduction in linehaul operating costs from the existing operating costs. The linehaul operating costs may have three major contributors and are obtained by combining the full mile cost, empty mile cost, and wait cost. One of the non-quantifiable efficiency gains is higher customer satisfaction, which results from providing customers with better service. The other non-quantifiable benefits include higher planner satisfaction because most of the operational decisions are made by the optimization system.

The foregoing description has been presented for purposes of illustration. It is not exhaustive and is not limited to precise forms or embodiments disclosed. Modifications and adaptations of the embodiments will be apparent from a consideration of the specification and practice of the disclosed embodiments. For example, while certain components have been described as being coupled to one another, such components may be integrated with one another or distributed in any suitable fashion.

Moreover, while illustrative embodiments have been described herein, the scope includes any embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, suitable modifications and equivalents may be resorted to, falling within the scope of the disclosure.

Other embodiments will be apparent from a consideration of the specification and practice of the embodiments disclosed herein. It is intended that the specification and examples be considered as an example, with a true scope and spirit of the disclosed embodiments being indicated by the following claims.

What is claimed is:

1. A shipment delivery system, including:
a plurality of shipments for delivery to a destination station from an origin station;
a plurality of equipment units configured to deliver the shipments;
a storage medium storing instructions; and
a processor configured to execute the stored instructions to perform operations comprising:
receiving information associated with a configuration of a baseline line haul network for transporting the shipments between the origin station and the destination station, the information including a plurality of scheduled paths between the origin station and the destination station.
receiving at least one constraint associated with modifying the baseline line haul network;
determining an alternate path different from the scheduled paths, the alternate path including an adhoc route between the origin station and the destination station;
determining an objective function associated with transporting the shipments from the origin station to the destination station using selected ones of the scheduled paths and the alternate path, and at least one equipment unit from the plurality of equipment units;
generating an optimized line haul network based on the determined objective function and the at least one constraint; and
dispatching the at least one equipment unit for transporting the shipments from the origin station to the destination station based on the optimized line haul network.

2. The system of claim 1, wherein determining the objective function includes determining a cost of transporting the shipments from the origin station to the destination station.

3. The system of claim 2, wherein determining the cost of transporting the shipments includes:
determining a scheduled cost associated with transporting a portion of the shipments from the origin station to the destination station via the selected ones of the scheduled paths; and
determining an adhoc cost associated with transporting a remaining portion of the shipments from the origin station to the destination station via the alternate path.

4. The system of claim 2, wherein generating the optimized line haul network further includes:
determining a baseline cost of transporting the shipments from the origin station to the destination station using the baseline line haul network; and
generating an updated line haul network including selected ones of the scheduled paths and the alternate path when the cost is less than the baseline cost.

5. The system of claim 1, wherein the information associated with the baseline line haul network further includes at least one of
one or more scheduled routes between the origin station and the destination station,
one or more adhoc routes between the origin station and the destination station,
a number and type of scheduled equipment units configured to travel on the one or more scheduled routes,
a number and type of adhoc equipment units configured to travel on the one or more adhoc routes, and
costs associated with the one or more scheduled routes and the one or more adhoc routes.

6. The system of claim 5, wherein each of the scheduled routes includes at least one leg comprising one intermediate starting station and one intermediate ending station.

7. The system of claim 1, wherein the at least one constraint includes one of
a minimum service level, including a number of shipments that must be delivered before a committed delivery time,
a maximum number of adhoc paths allowable in one or more alternate paths, the alternate path being selected from among the one or more alternate paths,
a minimum number of scheduled paths that must be included in the one or more alternate paths,
a target cost of operating the optimized line haul network, or
a target utilization level for the optimized line haul network.

8. The system of claim 1, wherein determining the objective function further includes determining a service level comprising a number of shipments delivered to the destination station before a committed delivery time using the selected ones of the scheduled paths and the alternate path.

9. The system of claim 8, wherein generating the optimized line haul network further includes:
determining a baseline cost of transporting the shipments from the origin station to the destination station using the baseline line haul network; and
generating an updated line haul network by including the alternate path in the optimized line haul network when the cost is less than the baseline cost and the service level exceeds a target service level.

10. The system of claim 1, wherein generating the optimized line haul network configuration further includes:
unassigning at least one scheduled equipment unit from at least one of the scheduled paths;
unassigning at least one adhoc equipment unit from the alternate path;
assigning the at least one scheduled equipment unit to a new scheduled path different from the at least one scheduled path;
assigning the at least one adhoc equipment unit to a new alternate path different from the alternate path; and
re-evaluating the objective function based on the new scheduled path and the new alternate path.

11. The system of claim 1, wherein the information includes a plurality of parameters associated with the baseline line haul network, the constraint includes a maximum number of modifications, and generating the optimized line haul network includes:
generating a modified line haul network by modifying a parameter selected from the plurality of parameters;
determining the objective function for the modified line haul network; and
outputting the modified line haul network as an updated line haul network when the objective function is less than a baseline objective function associated with the baseline line haul network.

12. The system of claim 1, wherein the information includes a plurality of parameters associated with the baseline line haul network, the constraint includes a maximum number of modifications, and generating the optimized line haul network further includes:
generating a modified line haul network by modifying at least a first parameter selected from the plurality of parameters;
determining a first objective function for the modified line haul network;
outputting the modified line haul network as an updated line haul network when the first objective function is less than a baseline objective function associated with the baseline line haul network;
determining a number of parameters that are different in the updated line haul network compared to the baseline line haul network;
comparing the number of parameters with the maximum number of modifications;
when the number of parameters is equal to the maximum number of modifications, outputting the updated line haul network as the optimized line haul network; and
when the number of parameters is less than the maximum number of modifications,
generating a second modified line haul network by modifying at least a second parameter selected from updated parameters associated with the updated modified line haul network;
determining a second objective function for the second modified line haul network; and
outputting the second modified line haul network as the updated line haul network when the second objective function is less than the first objective function.

13. A method of delivering shipments, including
receiving, by a processor, information associated with a configuration of a baseline line haul network for transporting shipments between an origin station and a destination station, the information including a plurality of scheduled paths between the origin station and the destination station.
receiving, by the processor, at least one constraint associated with modifying the baseline line haul network;
determining, using the processor, an alternate path different from the scheduled paths, the alternate path including an adhoc route between the origin station and the destination station;
determining, using the processor, an objective function associated with transporting the shipments from the origin station to the destination station using selected ones of the scheduled paths and the alternate path;
generating, using the processor, an optimized line haul network based on the determined objective function and the at least one constraint; and
dispatching one or more equipment units for transporting the shipments from the origin station to the destination station based on the optimized line haul network.

14. The method of claim 13, wherein determining the objective function includes determining a cost of transporting the shipments from the origin station to the destination station.

15. The method of claim 14, wherein determining the cost of transporting the shipments includes:
determining a scheduled cost associated with transporting a portion of the shipments from the origin station to the destination station via the selected ones of the scheduled paths; and
determining an adhoc cost associated with transporting a remaining portion of the shipments from the origin station to the destination station via the alternate path.

16. The method of claim 14, wherein generating the optimized line haul network further includes:
determining a baseline cost of transporting the shipments from the origin station to the destination station using the baseline line haul network; and
generating an updated line haul network including selected ones of the scheduled paths and the alternate path when the cost is less than the baseline cost.

17. The method of claim 13, wherein determining the objective function further includes determining a service level comprising a number of shipments delivered to the destination station before a committed delivery time using the selected ones of the scheduled paths and the alternate path.

18. The method of claim 13, wherein generating the optimized line haul network further includes:
determining a baseline cost of transporting the shipments from the origin station to the destination station using the baseline line haul network; and
generating an updated line haul network by including the alternate path in the optimized line haul network when the cost is less than the baseline cost.

19. The method of claim 13, wherein the information includes a plurality of parameters associated with the baseline line haul network, the constraint includes a maximum number of modifications, and generating the optimized line haul network includes:
generating a modified line haul network by modifying a parameter selected from the plurality of parameters;
determining the objective function for the modified line haul network; and
outputting the modified line haul network as an updated line haul network when the objective function is less than a baseline objective function associated with the baseline line haul network.

20. The method of claim 13, wherein the information includes a plurality of parameters associated with the baseline line haul network, the constraint includes a maximum number of modifications, and generating the optimized line haul network further includes:
generating a modified line haul network by modifying at least one parameter selected from the plurality of parameters;
determining a first objective function for the modified line haul network;
outputting the modified line haul network as an updated line haul network when the first objective function is less than a baseline objective function associated with the baseline line haul network;
determining a number of parameters that are different in the updated line haul network compared to the baseline line haul network;
comparing the number of parameters with the maximum number of modifications;
when the number of parameters is about equal to the maximum number of modifications, outputting the updated line haul network as the optimized line haul network; and
when the number of parameters is less than the maximum number of modifications,
generating a second modified line haul network by modifying at least another parameter selected from updated parameters associated with the updated modified line haul network;
determining a second objective function for the second modified line haul network; and
outputting the second modified line haul network as the updated line haul network when the second objective function is less than the first objective function.
